(19) United States
(12) Patent Application Publication
(10) Pub. No.: US 2007/0168277 A1
(43) Pub. Date: Jul. 19, 2007

(54) Merchant credit issuance and monitoring systems and methods

(75) Inventor: Giancarlo Marchesi, Huntington, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/337,086

(22) Filed: Jan. 19, 2006

(51) Int. Cl. G06Q 40/00

(52) U.S. Cl. 705/38

(57) ABSTRACT

A method of extending credit to a merchant establishing a transaction processing relationship with the merchant and extending credit to the merchant contingent on the transaction processing relationship. Extending credit includes a right to collateralize funds resulting from the transaction processing relationship, otherwise due the merchant, if the merchant defaults on a payment due in the course of extending credit to the merchant.

### CROSS-REFERENCES TO RELATED APPLICATIONS

This application is related to the following co-pending, commonly assigned U.S. patent applications: application Ser. No. 10/108,781, entitled “DECISION TREE SYSTEMS AND METHODS” (Attorney Docket No. 020375-008200US), by Mark G. Arthus, et al.; application Ser. No. 10/109,198, entitled “MERCHANT APPLICATION AND UNDERWRITING SYSTEMS AND METHODS” (Attorney Docket No. 020375-007100US), by Michael L. Sgaraglio, et al.; application Ser. No. 10/108,934, entitled “MERCHANT ACTIVATION TRACKING SYSTEMS AND METHODS” (Attorney Docket No. 020375-023900US), by Michael L. Sgaraglio, et al.; application Ser. No. 10/108,575, entitled “SYSTEMS AND METHODS FOR MONITORING CREDIT RISK” (Attorney Docket No. 020375-008500US), by Michael L. Sgaraglio; and U.S. patent applications: application Ser. No. 11/241,765, entitled “PRESENTATION INSTRUMENT TRANSACTION PROCESSING PRICING SYSTEMS AND METHODS” (Attorney Docket No. 020375-067000US), by Giancarlo Marchesi, the entirety of each of which are herein incorporated by reference for all purposes.

### BACKGROUND OF THE INVENTION

Embodiments of the invention relate generally to credit issuance and monitoring systems. More specifically, embodiments of the invention relate to merchant credit card issuance and monitoring systems and methods.

Many merchants, particularly small business merchants, are not able to obtain credit, particularly revolving credit. Credit card issuers, such as banks and the like, simply deem such businesses not to be creditworthy. Small business merchants, however, comprise a large market for credit card issuers. Hence, systems and methods are needed to help credit card issuers access this market.

### BRIEF SUMMARY OF THE INVENTION

Embodiments of the invention thus provide a method of extending credit to a merchant. The method includes populating a processing system with one or more rules and establishing a transaction processing relationship with the merchant. In the transaction processing relationship a transaction processor receives credit tickets resulting from purchases by consumers of the merchant's goods or services, obtains funds from the consumers, and remits at least a portion of the funds to the merchant. The method further includes extending credit to the merchant contingent on the transaction processing relationship. Extending credit to the merchant includes a right to collateralize funds resulting from the transaction processing relationship, otherwise due the merchant, if the merchant defaults on a payment due in the course of extending credit to the merchant. Extending credit to the merchant also includes creating an account relating to the merchant. The method also includes receiving transaction processing data relating to the merchant, receiving credit account information relating to the account of the merchant, applying one or more rules to the transaction processing data relating to the merchant and the credit account information relating to the account of the merchant, and, based on the application of the rules to the information, determining whether to collateralize funds due the merchant resulting from the transaction processing relationship.

In some embodiments, a first one of the one or more rules allows collateralization of the funds if the account of the merchant becomes delinquent more than a predetermined number of days. The predetermined number of days may be exactly 74 days. If the account of the merchant becomes delinquent more than 74 days, the method also may include withholding a percentage of funds due the merchant from the transaction processing relationship. The percentage may be 50%. A second one of the one or more rules may allow collateralization of the funds if a score relating to the merchant exceeds a predetermined threshold. The score may include a factor relating to goods sold by the merchant. The score may include a factor relating to a delivery schedule for goods or services sold by the merchant. A third one of the one or more rules may allow collateralization of the funds if a score relating to a proprietor of the merchant falls by a predetermined amount. The score may include a credit score. The credit score may be a Fair Isaac Corporation (FICO) score.

In other embodiments, a method of extending credit to a merchant includes establishing a transaction processing relationship with the merchant in which a transaction processor receives credit tickets resulting from purchases by consumers of the merchant's goods or services, obtains funds from the consumers, and remits at least a portion of the funds to the merchant. The method also includes extending credit to the merchant contingent on the transaction processing relationship. Extending credit to the merchant includes the right to collateralize funds resulting from the transaction processing relationship, otherwise due the merchant, if the merchant defaults on a payment due in the course of extending credit to the merchant. Extending credit to the merchant also includes creating an account relating to the merchant. The method also includes receiving account information relating to the account of the merchant and evaluating the account information to determine whether to collateralize funds due the merchant resulting from the transaction processing relationship.

In some embodiments, evaluating the account information to determine whether to collateralize funds due the merchant resulting from the transaction processing relationship includes determining whether the account of the merchant is delinquent more than a predetermined number of days. The account of the merchant may relate to a credit card account.

In still other embodiments, a method of extending credit to a merchant includes establishing a transaction processing relationship with the merchant in which a transaction processor receives credit tickets resulting from purchases by consumers of the merchant's goods or services, obtains funds from the consumers, and remits at least a portion of the funds to the merchant. The method also includes extending credit to the merchant contingent on the transaction processing relationship. Extending credit to the merchant includes a right to collateralize funds resulting from the transaction processing relationship, otherwise due the merchant, if the merchant defaults on a payment due in the course of extending credit to the merchant. Extending credit to the merchant also includes creating an account relating to the merchant. The method also includes receiving transaction processing data relating to the merchant and evaluating the transaction processing data to determine whether to collateralize funds due the merchant resulting from the transaction processing relationship.

In some embodiments, evaluating the transaction processing data to determine whether to collateralize funds due the merchant resulting from the transaction processing relationship includes calculating a credit risk score relating to the transaction processing relationship and comparing the score to a predetermined threshold. The transaction processing relationship may be a credit card processing relationship.

In still other embodiments, a method of extending credit to a merchant includes establishing a transaction processing relationship with the merchant in which a transaction processor receives credit tickets resulting from purchases by consumers of the merchant's goods or services, obtains funds from the consumers, and remits at least a portion of the funds to the merchant. The method also includes extending credit to the merchant contingent on the transaction processing relationship. Extending credit to the merchant includes a right to collateralize funds resulting from the transaction processing relationship, otherwise due the merchant, if the merchant defaults on a payment due in the course of extending credit to the merchant. Extending credit to the merchant also includes creating an account relating to the merchant. The method also includes receiving credit information relating to a proprietor of the merchant and evaluating the credit information relating to the proprietor of the merchant to determine whether to collateralize funds due the merchant resulting from the transaction processing relationship.

In some embodiments, evaluating the credit information relating to the proprietor of the merchant to determine whether to collateralize funds due the merchant resulting from the transaction processing relationship includes determining whether a score relating to the proprietor of the merchant has fallen below a predetermined threshold. The score may be a Fair Isaac Corporation (FICO) score.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary system according to embodiments of the invention.

FIG. 2 illustrates an exemplary method according to embodiments of the invention, which method may be implemented in the system of FIG. 1.

FIG. 3 illustrates an exemplary underwriting process according to embodiments of the invention, which may be implemented in the system of FIG. 1.

FIG. 4 illustrates a specific exemplary collateralization method according to embodiments of the invention, which may be implemented in the system of FIG. 1.

### DETAILED DESCRIPTION OF THE INVENTION

Embodiments of the invention relate to merchant credit card issuance and monitoring systems and methods. According to embodiments of the invention, merchants otherwise unable to obtain credit are extended credit via the systems and methods of the present invention. Merchants are extended credit based on certain conditions, which are monitored by the systems and methods of the present invention. Creditworthy merchants also may be issued credit according to the present invention and may receive certain benefits in return.

Banks and other financial institutions that issue credit to merchants (hereinafter “issuer”), particularly revolving credit, are reluctant to issue credit to some merchants for a number of reasons. For example, many small businesses have few or no assets which may collateralized if the merchant defaults or goes out of business completely. Many such businesses, however, accept credit cards in exchange for their offered goods and/or services, the unreimbursed receipts for which are an accounts receivable asset.

According to embodiments of the invention, credit card transaction processors (hereinafter “processor”) and issuers may cooperate, through the systems and methods of the present invention, to issue credit to merchants using the merchants' accounts receivable as collateral. The credit card issuance system of the present invention periodically receives information regarding the merchant's credit card accounts receivable from a credit card transaction processing system. It also receives account status information relating to credit cards or other presentations instruments issued to the merchant from the merchant's credit card issuer or the issuer's processing system. As long as the merchant's credit card account remains in good standing, no action is taken. If, however, the merchant neglects to make required payments on its credit card account, funds otherwise due the merchant may be collateralized. In some embodiments, this entails actually paying the funds to the merchant's credit card issuer. In other embodiments, this entails holding the funds for a longer than normal period in anticipation of the merchant making the required payment. Many other examples are possible.

Any of a number of conditions may result in a merchant's accounts receivable being collateralized. For example, the merchant may neglect to make a required payment; the merchant may exceed its credit limit; the merchant may change processors; the merchant may take actions that reduce the merchant's credit card accounts receivable; and/or the like. The conditions may be embodied in rules in the credit card issuance system of the present invention. The rules are thereafter used to monitor the information received from the merchant's processor and the merchant's issuer. If the conditions of a particular rule are satisfied, the system may issue a letter to the merchant, alert a collections agent, signal the credit card transaction processing system to delay credit card account receivable funds deposits into the merchant's account, cause the transaction processing system to redirect payments to the merchant's credit card issuer, increase the interest rate the merchant pays for credit, and/or the like. Many other examples are possible.

It is to be appreciated that embodiments of the invention are not limited to credit card issuance or even revolving credit issuance. Credit may be issued to merchants, for example, in the form of loans. Further, embodiments of the invention are not limited to systems and methods for issuing credit cards to otherwise unworthy merchants. High risk merchants or even highly creditworthy merchants may be issued credit according to embodiments of the invention in exchange for better terms on their credit card accounts (e.g., lower interest rates), advantaged pricing (e.g., less holdback on charge transactions by the merchant's customers), and/or the like.

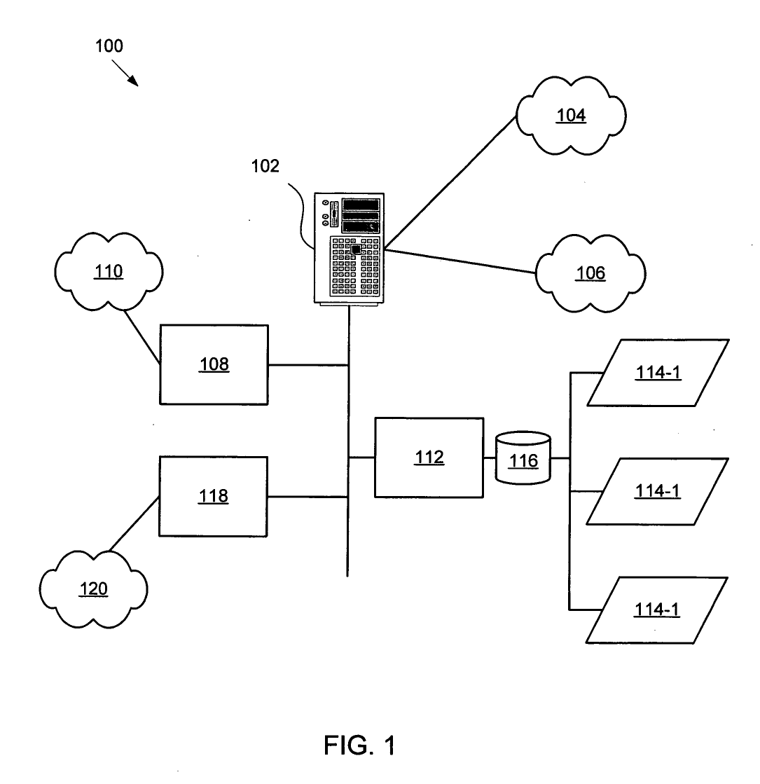

Having described embodiments of the present invention generally, attention is directed to FIG. 1, which illustrates an exemplary system 100 according to embodiments of the invention. Those skilled in the art will appreciate that the system 100 is merely exemplary of a number of possible systems according to embodiments of the invention. The system 100 includes a front end 102 that communicates with external and internal systems. The front end 102 may be any of a variety of suitable computing devices, including, for example, a server computer, a mainframe computer, a workstation, and/or the like.

The front end 102 is configured to receive information from at least two external sources: a credit card transaction processing system 104; and a merchant transaction processing system 106. The credit card transaction processing system 104 processes transactions relating to a credit card issued to a merchant. Periodically the merchant receives a statement that summarizes charges made by the merchant. The merchant's payment history and/or other information is/are periodically provided to the front end 102. If the merchant becomes delinquent, that information is used by the front end and its associated processing environments to initiate or continue collateralization activities. While only one credit card transaction processing system 104 is shown, if credit cards are issued to multiple merchants, whose transactions are processed by multiple different systems, then the front end 102 may receive account information from more than one credit card transaction processing system 104.

The merchant transaction processing system 106 processes charges made by a merchant's customers. The merchant transaction processing system 106 receives the merchant's daily receipts, collects from the merchant's customers, and remits funds, usually as a direct deposit into the merchant's bank account. The merchant transaction processing system 106 provides information to the front end 104 such as daily volume of merchant receipts, classes of goods sold, delayed delivery transactions, and the like.

In this exemplary embodiment, the front end 102 is interfaced to at least three processing environments. While the front end 102 and the various processing environments are illustrated and described herein as different devices, in practice, the front end 102 and the three processing environments may be comprised by a single computing device. One processing environment is a scoring engine 108. The scoring engine 108 receives data from one or more external sources 110 and uses the data to calculate one or more scores related to a particular merchant. For example, the scoring engine 108 may receive a Fair Isaac Corporation (FICO) credit score on the merchant proprietor individually. The scoring engine 108 may receive information related to transactions processed by the merchant that may be used to calculate a credit risk score or a credit fraud score. For example, a merchant may be processing transactions outside the merchant's area of business, which may be a fraud indicator. The merchant may be processing delayed delivery transactions, which increases the credit risk associated with the merchant. Many other examples are possible. As will be described in more detail hereinafter, various scores may be used in rules to determine whether to begin collateralization activity of the merchant's receipts.

The front end 102 is also interfaced to a risk management workstation 112. The risk management workstation 112 uses scoring information from the scoring engine 108 and account processing data from the other external environments 104, 106 to determine whether to initiate and/or continue collateralization activity for a particular merchant. The risk management workstation 112 bases collateralization decisions on rules 114. Rules 114 may be added to, modified in, or deleted from a rule database 116. Rules may relate to, for example, a merchant's credit card account behavior 114-1, events relating to processing a merchant's transactions 114-2, and/or events relating to a merchant's proprietor's credit worthiness behavior 114-3.

Events relating to a merchant's credit card account behavior may include, for example, a merchant being more than 75 days delinquent in making a required payment on the account. If this event is triggered, collateralization of the merchant's receipts may begin in which a portion (e.g., 50%) of the merchant's receipts are held in escrow. If the account remains delinquent after 105 days, the amount held in escrow may be paid to the merchant's credit card issuer. Hence, appropriate rules may be constructed to monitor incoming data to determine whether the associated events take place. Events relating to processing a merchant's transactions may include a default by the merchant on a payment due for leased processing equipment. Other events may include deterioration in a merchant's credit or fraud scores that indicate an increasing risk of loss. In such cases, collateralization may begin to cover the increased expected loss, and rules may be written to cover the event and trigger the action. Events relating to a merchant's proprietor's credit worthiness behavior may include a deterioration of 20% in the individual's FICO score. If the issuer of the credit card wishes to terminate the relationship, collateralization may begin to cover any outstanding balance. Those skilled in the art will appreciate that the foregoing examples are merely exemplary.

The front end 102 is also interfaced to a collateralization workstation 118. Once collateralization is triggered, the collateralization workstation 118 manages the collateralization process. The collateralization workstation 118 also interfaces to one or more external environments 120, such as the processing environment of the issuer of the merchant's credit card.

The foregoing description of the system 100 of FIG. 1 is understood to be exemplary. In some embodiments, the functionality of the individual system elements described above may be combined into a single processing environment operated by, for example, the merchant's transaction processor. The functionality may be marketed to credit card issuers as a way to lower the risk of issuing credit cards to merchants, thereby increasing the issuer's potential market. It is also to be understood that the system 100 may be applied to any number of merchant accounts simultaneously.

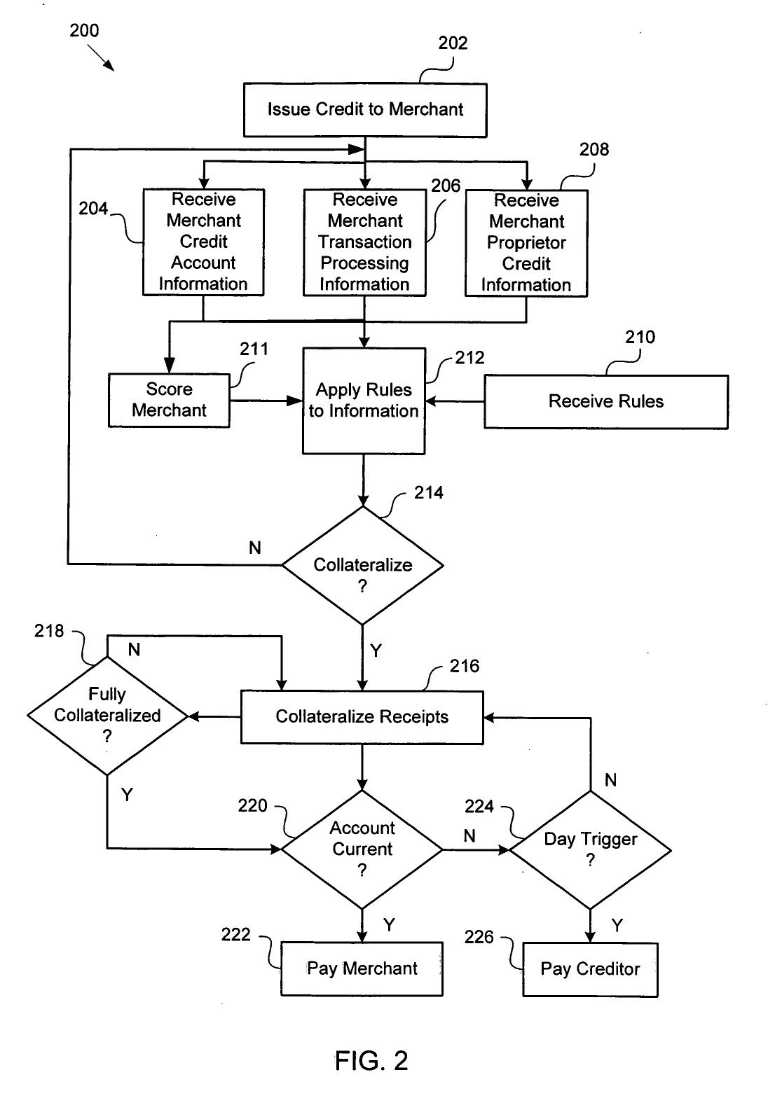

Having described a system 100 according to embodiments of the invention, attention is directed to FIG. 2, which illustrates an exemplary method 200 according to embodiments of the invention. The method 200 may be implemented in the system 100 of FIG. 1 or in other appropriate systems. Other exemplary embodiments may include more, fewer, or different steps than those illustrated and described herein. Further, the steps illustrated and described herein may be traversed in different orders than shown.

The method 200 begins at block 202 at which point credit is extended to a merchant. The merchant may be any entity that accepts credit cards in exchange for goods or services. Credit may be extended in the form of a loan, a revolving charge account, or the like. In whatever form the credit is issued, the credit agreement includes a provision allowing the issuer to collateralize receipts resulting from processing purchase transactions made by the merchant's customers.

At block 204, information is received from a credit card processing system. The credit card processing system processes transactions initiated by the merchant using the credit card issued at block 202. The information may include, for example, the current status of the account, including the number of days the merchant is delinquent in making a required payment, if any.

At block 206, information is received relating to processing the merchant's transactions. Such information may include the volume of charged sales transactions, the types of transactions, the specific goods or services purchased, the delivery schedule of the goods or services, and/or the like. The information may be used to calculate scores, such as credit risk and fraud scores, or otherwise develop measurable data to be used during the rule evaluation process discussed below.

At block 208, merchant proprietor credit information is received. Such information may include, for example, a credit score relating to the merchant's proprietor. The score may be, for example, a FICO score.

At block 210 rules are created and stored. As previously described, rules may be developed to identify any condition that should trigger collateralization. The rules may relate to behavior relating to a merchant's credit card account, behavior relating to credit purchase transactions of the merchant's goods and/or services, behavior relating to a merchant's proprietor's credit worthiness, and/or the like.

At block 211, a merchant score may be calculated using the data provided at one or more of blocks 204, 206, 208. While credit scores may be readily available for a merchant, merchant proprietor, or principal responsible officer of the merchant, scores are not readily available for relating to merchant processing. For example, data relating to actual purchase transactions processed by the merchant may be useful in determining a “risk of loss” associated with the merchant. The score or scores may include factors relating to credit to develop a predictive model for determining the risk of both processing the merchant's transaction and issuing credit to the merchant. The scores may then be used in combination with the rules from block 210 to make collateralization decisions.

At block 212, the rules are applied to the information received at blocks 204, 206, 208. At block 214, a decision is made, based on the application of the rules to the data, whether to collateralize receipts due the merchant. If no rule triggers collateralization, then the process loops back to the point after block 202. If, however, a rule triggers collateralization, then collateralization begins at block 216.

Once collateralization is triggered, at block 216, some portion of the merchant's receipts are collateralized in a given period of time. In a specific example, 50% of a merchant's daily receipts are collateralized. In other embodiments, different percentages may be collateralized on a different schedule. After each period, a decision is made at block 218 whether an amount equaling the merchant's credit card balance has been fully collateralized. If not, collateralization continues. If an amount equaling the outstanding balance is fully collateralized, then the process continues at block 220.

Collateralized funds are initially held in an escrow account in most embodiments. At block 220, a determination is made whether the merchant's credit card account has been brought current. If so, the collateralized funds held in escrow are remitted to the merchant. If not, the process continues at block 224.

At block 224, a determination is made whether a sufficient about of time has passed to pay the merchant's creditor, such as the merchant's credit card issuer. In some cases, collateralization begins when a credit account of the merchant is 75 days delinquent. Once the account reaches 105 days delinquent, funds are remitted to the merchant's creditor at block 226. In other embodiments, the day trigger may be more of fewer than 105 days. If the day trigger has not been reached, the process loops back to a previous state, such as block 216. Those skilled in the art will appreciate that different rules will trigger collateralization in different ways, resulting in different paths through the process of FIG. 2.

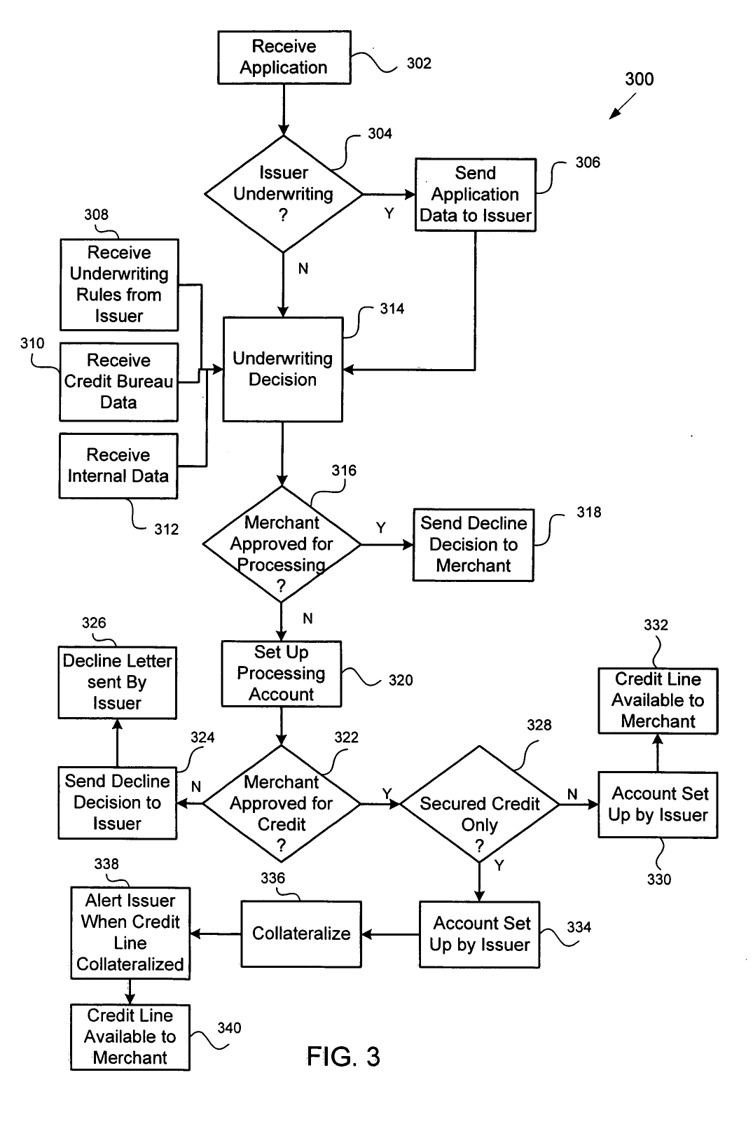

The method of FIG. 2 begins with the issuance of credit to a merchant at block 202. Prior to having credit extended to it, however, a merchant typically must undergo an underwriting process. FIG. 3 illustrates an exemplary underwriting process 300 according to embodiments of the invention. The underwriting process 300 begins with the receipt of an application at block 302. In some embodiments, the merchant has a previously-established processing relationship and is seeking credit from an issuer. In some embodiments, the merchant already has a credit relationship with an issuer and is seeking a processing relationship with the processor. In exchange for establishing the processing relationship, the merchant may receive a better interest rate on credit extended in the credit relationship. In some embodiments, the merchant has neither a processing relationship with the processor nor a credit relationship with the issuer. The method 300 may be used to underwrite the merchant in any of the foregoing cases. Those skilled in the art will appreciate which steps need not be traversed, depending on the merchant's status prior to underwriting.

At block 304 a decision is made whether the credit underwriting is done by the issuer or the processor. Since the method 300 assumes the application is submitted to the processor, relevant application data is sent to the issuer at block 306 if the issuer is to do the underwriting. Otherwise, the process proceeds to underwriting. Those skilled in the art will appreciate that if the application is submitted to the issuer, then appropriate information may be sent to the processor for underwriting.

Various data may be required to complete the underwriting process. Hence, at block 308, underwriting rules are received from the issuer. Different issuers may have different underwriting rules, and the processor may underwrite merchant for a number of issuers. Hence, underwriting rules may be complied and stored for later use. When a merchant is being underwritten for a particular issuer, then the applicable underwriting rules for that issuer are user. At block 310, credit bureau data relating to the merchant is received. This may be a FICO score, a complete credit report, and/or the like. The data may relate to the merchant's owner or ownership group, the merchant itself, or any principle of the merchant. At block 312, internal data of the processor may be included in the underwriting process. For example, if the merchant has a pre-established processing relationship with the processor, then the data relating to that relationship may be used. Those skilled in the art will appreciate that other types and varieties of data may be used from any f a number of other sources, both internal and external.

At block 314, underwriting decisions are reached and/or reported. If the underwriting process takes place entirely within the processor's control, then the process continues at block 316. If, however, the issuer is accomplishing a portion of the underwriting, then the issuer's decision is received at block 314.

At block 316, a determination is made whether the merchant is approved from processing (assuming the relationship did not exist previously). If the merchant is declined for processing, then an appropriate letter is sent at block 318. If, however, the merchant is approved for processing, then the account is set up at block 320. Account set up for processing may include setting pricing, establishing a reserve account, and the like.

At block 322, a determination is made whether the merchant is accepted for credit. If not, the decline decision is sent to the issuer at block 324 and a decline letter is sent by the issuer at block 326. If, however, the merchant is accepted for credit, the method continues at block 328.

If the merchant is accepted for credit, it may be that the merchant is accepted for a secured account only. That decision is made at block 328. If the merchant is accepted on an unsecured basis, then the account is set up by the issuer at block 330 and credit is extended to the merchant at block 332. If a secure account is required, then the account is set up by the issuer at block 334, and the merchant's processing receipts are collateralized at block 336 until the security account has the necessary balance. Once the security account is properly funded by merchant receipts, the issuer is informed at block 338 and the credit line becomes available to the merchant at block 340. Thereafter, the need for a security account may be periodically evaluated and the proceeds returned to the merchant if the account becomes unnecessary.

Following credit being made available to the merchant at either block 332 or block 340, the process may continue at block 202 of FIG. 2.

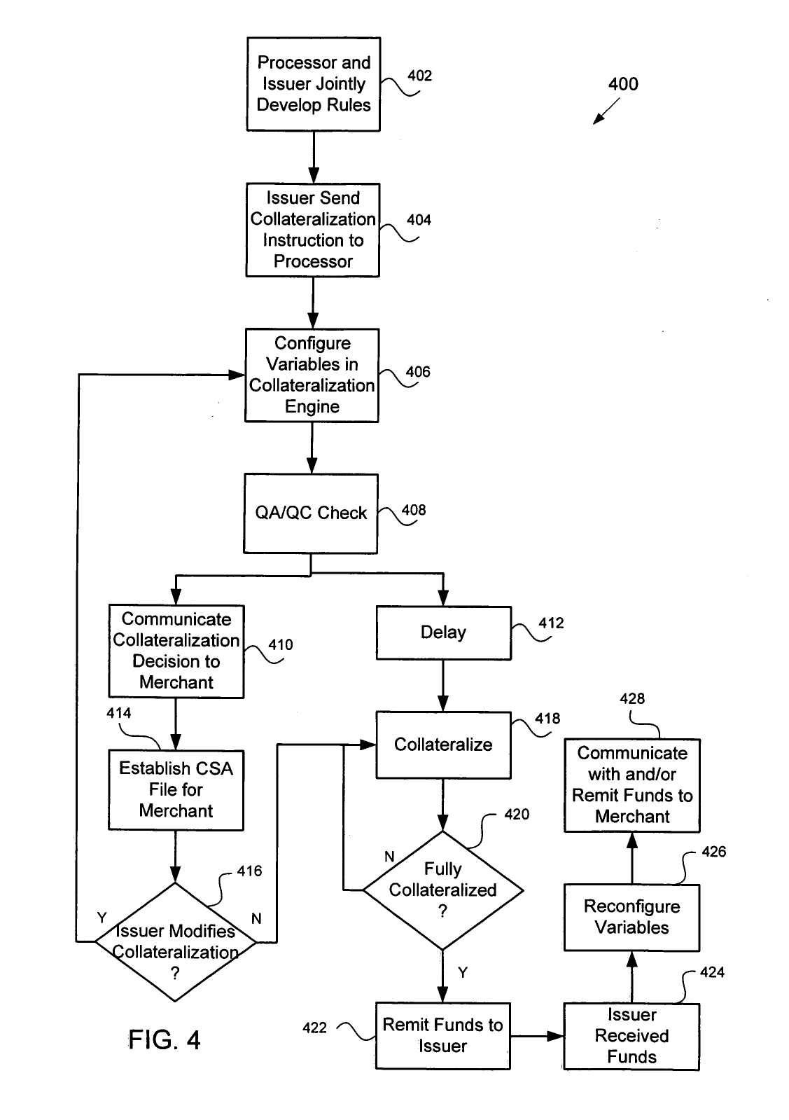

Attention is now directed to FIG. 4, which illustrates a specific example of a collateralization process 400 according to embodiments of the invention. In many respects, the process 400 is substantially similar to the process 200 of FIG. 2. The process begins at block 402 at which point a processor and an issuer jointly agree to collateralization rules for one or more merchants. It may be assumed that the underwriting process of FIG. 3 or other suitable underwriting process results in one or more acceptable merchants to whom the issuer extends credit and for whom the processor processes transactions.

At block 404, a merchant is identified by the issuer for collateralization of merchant receipts, and the issuer sends a collateralization instruction to the processor. The instruction includes, for example, a merchant id#, an account #, an amount to collateralize, a percentage of daily processing receipts to collateralize, and/or the like. The necessary variables are used to configure the processor's collateralization engine at block 406. A quality assurance/quality control check may be employed at block 408.

At block 410, a collateralization decision is communicated to the merchant while a built in delay in the collateralization process take place at block 412. The delay allows time for the merchant to be alerted to the collateralization, to contact the issuer and/or processor, and/or to bring its credit card account current.

At block 414, a customer service file is populated for the merchant. The file, which is electronic in most embodiments, may be used to quickly respond to inquires from the merchant or others relating to the collateralization of the merchant's receipts. If the merchant contacts the issuer or the processor, terms may be negotiated that modify the collateralization variables previously used to populate the collateralization engine. A decision to this effect is made at block 416, and the process loops back to block 406 if the variables are changed. Otherwise, the process continues at block 418.

Collateralization begins at block 418 by withholding the appropriate percentage from the merchant's daily processing receipts. A decision is made at block 420 whether the target collateralization amount is collateralized, and the process continues through blocks 418 and 420 until the amount is fully collateralized, at which point the process continues at block 422.

Once the amount is fully collateralized and after an appropriate time period (e.g., 105 or more days delinquent), funds may be remitted to the issuer at block 422. The issuer receives funds at block 424 and communicates variables back to the processor for reconfiguring the collateralization engine at block 426. At block 428, the payment of funds to the issuer is reported to the merchant and any excess funds are paid to the merchant.

Those skilled in the art will appreciate that the process 400 is merely exemplary of a number of possible embodiments.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention, which is defined in the following claims.

What is claimed is:

1. A method of extending credit to a merchant, comprising:
populating a processing system with one or more rules;
establishing a transaction processing relationship with the merchant, whereby a transaction processor:
receives credit tickets resulting from purchases by consumers of the merchant's goods or services;
obtains funds from the consumers; and
remits at least a portion of the funds to the merchant;
extending credit to the merchant contingent on the transaction processing relationship, wherein extending credit to the merchant includes a right to collateralize funds resulting from the transaction processing relationship, otherwise due the merchant, if the merchant defaults on a payment due in the course of extending credit to the merchant and wherein extending credit to the merchant includes creating an account relating to the merchant;
receiving transaction processing data relating to the merchant;
receiving credit account information relating to the account of the merchant;
applying one or more rules to the transaction processing data relating to the merchant and the credit account information relating to the account of the merchant; and
based on the application of the rules to the information, determining whether to collateralize funds due the merchant resulting from the transaction processing relationship.

2. The method of claim 1, wherein a first one of the one or more rules allows collateralization of the funds if the account of the merchant becomes delinquent more than a predetermined number of days.

3. The method of claim 2, wherein the predetermined number of days is 74 days.

4. The method of claim 3, wherein the account of the merchant becomes delinquent more than 74 days, the method further comprising:
based on the determination, withholding a percentage of funds due the merchant from the transaction processing relationship.

5. The method of claim 4, wherein the percentage is 50%.

6. The method of claim 1, wherein a second one of the one or more rules allows collateralization of the funds if a score relating to the merchant exceeds a predetermined threshold.

7. The method of claim 6, wherein the score includes a factor relating to goods sold by the merchant.

8. The method of claim 6, wherein the score includes a factor relating to a delivery schedule for goods or services sold by the merchant.

9. The method of claim 1, wherein a third one of the one or more rules allows collateralization of the funds if a score relating to a proprietor of the merchant falls by a predetermined amount.

10. The method of claim 9, wherein the score comprises a credit score.

11. The method of claim 10, wherein the credit score comprises a Fair Isaac Corporation (FICO) score.

12. A method of extending credit to a merchant, comprising:
establishing a transaction processing relationship with the merchant, whereby a transaction processor:
receives credit tickets resulting from purchases by consumers of the merchant's goods or services;
obtains funds from the consumers; and
remits at least a portion of the funds to the merchant;
extending credit to the merchant contingent on the transaction processing relationship, wherein extending credit to the merchant includes the right to collateralize funds resulting from the transaction processing relationship, otherwise due the merchant, if the merchant defaults on a payment due in the course of extending credit to the merchant and wherein extending credit to the merchant includes creating an account relating to the merchant;
receiving account information relating to the account of the merchant; and
evaluating the account information to determine whether to collateralize funds due the merchant resulting from the transaction processing relationship.

13. The method of claim 12, wherein evaluating the account information to determine whether to collateralize funds due the merchant resulting from the transaction processing relationship comprises determining whether the account of the merchant is delinquent more than a predetermined number of days.

14. The method of claim 13, wherein the account of the merchant relates to a credit card account.

15. A method of extending credit to a merchant, comprising:
establishing a transaction processing relationship with the merchant, whereby a transaction processor:
receives credit tickets resulting from purchases by consumers of the merchant's goods or services;
obtains funds from the consumers; and
remits at least a portion of the funds to the merchant;
extending credit to the merchant contingent on the transaction processing relationship, wherein extending credit to the merchant includes a right to collateralize funds resulting from the transaction processing relationship, otherwise due the merchant, if the merchant defaults on a payment due in the course of extending credit to the merchant and wherein extending credit to the merchant includes creating an account relating to the merchant;
receiving transaction processing data relating to the merchant; and
evaluating the transaction processing data to determine whether to collateralize funds due the merchant resulting from the transaction processing relationship.

16. The method of claim 15, wherein evaluating the transaction processing data to determine whether to collateralize funds due the merchant resulting from the transaction processing relationship comprises:
calculating a credit risk score relating to the transaction processing relationship; and
comparing the score to a predetermined threshold.

17. The method of claim 16, wherein the transaction processing relationship comprises a credit card processing relationship.

18. A method of extending credit to a merchant, comprising:
establishing a transaction processing relationship with the merchant, whereby a transaction processor:
receives credit tickets resulting from purchases by consumers of the merchant's goods or services;
obtains funds from the consumers; and
remits at least a portion of the finds to the merchant;
extending credit to the merchant contingent on the transaction processing relationship, wherein extending credit to the merchant includes a right to collateralize funds resulting from the transaction processing relationship, otherwise due the merchant, if the merchant defaults on a payment due in the course of extending credit to the merchant and wherein extending credit to the merchant includes creating an account relating to the merchant;
receiving credit information relating to a proprietor of the merchant; and
evaluating the credit information relating to the proprietor of the merchant to determine whether to collateralize finds due the merchant resulting from the transaction processing relationship.

19. The method of claim 18, evaluating the credit information relating to the proprietor of the merchant to determine whether to collateralize funds due the merchant resulting from the transaction processing relationship comprises determining whether a score relating to the proprietor of the merchant has fallen below a predetermined threshold.

20. The method of claim 19, wherein the score comprises a Fair Isaac Corporation (FICO) score.
